(19) United States
(12) Patent Application Publication
(10) Pub. No.: US 2002/0097023 A1
(43) Pub. Date: Jul. 25, 2002

(54) MEMORIZING THE FIRST OPERATING TIME OF A STAND-BY BATTERY AND/OR INDICATING THE END OF A STAND-BY BATTERY LIFETIME

(76) Inventors: THOMAS FISCHEDICK, RAESFELD (DE); ANDRE MULLER, HAMMINKELN-DINGDEN (DE)

Correspondence Address: BELL, BOYD & LLOYD, LLC, P. O. BOX 1135, CHICAGO, IL, 60690-1135, US

(21) Appl. No.: 09/485,308

(22) PCT Filed: Jul. 29, 1998
(86) PCT No.: PCT/DE98/02171

(30) Foreign Application Priority Data
Aug. 6, 1997 (DE) 197 34 057.1

(51) Int. Cl. H02J 7/00

(52) U.S. Cl. 320/134

(57) ABSTRACT

A backup battery for buffering the operating voltage of a circuit arrangement is realized by a battery combined with an electrically irreversible element established by a melt fuse to form a unit. When the irreversible element exhibits its original condition when monitored, it is placed into the irreversible condition and the point in time is stored. As a result of the positive identification of the point in time of the initial commissioning of the backup battery, a premature replacement of the battery before expiration of the guaranteed service life that may appear necessary due to security considerations is avoidable. In a specific development, reaching the end of the service life of the backup battery is marked by the irreversible element.

The subject matter of the application is directed to a specific embodiment of a backup battery and to a method for storing the point in time of the initial commissioning of a backup battery and/or marking when the end of the service life of a backup battery is reached.

Electrical devices supplied from the public mains network and having high demands made of the availability comprise a backup battery for bridging a network outage that can be established by an accumulator. Since the service life of an accumulator exhibits an age-conditioned limit, the accumulator must be replaced when the guaranteed service life has been reached. The point in time of the initial utilization of the accumulator is the determining factor for monitoring the expiration of the guaranteed service life. Given a program-controlled interrogation of the operating voltage of the accumulator, first, a distinction cannot be made between and new and an old accumulator and, second, a replacement of the accumulator carried out during a network outage cannot be recognized. As a result, the program-controlled interrogation must be based on the worst case that is established by a required replacement of the accumulator.

One possibility of countering this problem is comprised in communicating the replacement of the accumulator to some other means with a separate power supply such as, for example, a higher-ranking switching means on the basis of an input manually effected by an operator.

FR-2 621 176 discloses an ignition detector for ignition cells wherein a piston movable in a hollow member can be moved between a quiescent position and a locking position, and whereby an electrical circuit is closed when the piston is in the quiescent position and is opened when the piston is in the locking position.

The subject matter of the application is based on the problem of specifying a circuit arrangement and method for the operation of the circuit arrangement with which the point in time of the initial commissioning of a backup battery can be unambiguously identified or, respectively, with which the end of the service life of the backup battery can be unambiguously marked.

The problem is solved by an arrangement according to claim 1 or, respectively, by a method according to claim 9.

The subject matter of the application avoids an uneconomical, premature replacement of a backup battery that, moreover, is accompanied by unnecessary ecological pollution.

Further advantageous developments of the subject matter of the application are recited in the subclaims.

According to a specific method for recognizing the end of the service life of a backup battery in a circuit arrangement wherein a backup battery arranged in common and an element that is permanently irreversible with respect to electrically interrogatable quantities on the basis of a power surge are replaceable, the following method steps are established:

determination of the maximum amount of charge that can be taken from the backup battery;

setting the element into the irreversible condition when the maximum amount of charge that can be taken falls below a predetermined limit value.

Upon interrogation of the element, this measure makes it possible to unambiguously distinguish a backup battery that has reached the end of its service life.

According to a particular embodiment of the subject matter of the application, the backup battery comprises two elements. This measure yields both an unambiguous determination of the point in time of the initial commissioning of a backup battery as well as an unambiguous distinguishability of the backup battery that has reached the end of its service life.

The subject matter of the application is described as an exemplary embodiment in greater detail below on the basis of two Figures and in a scope necessary for understanding.

Thereby shown are:

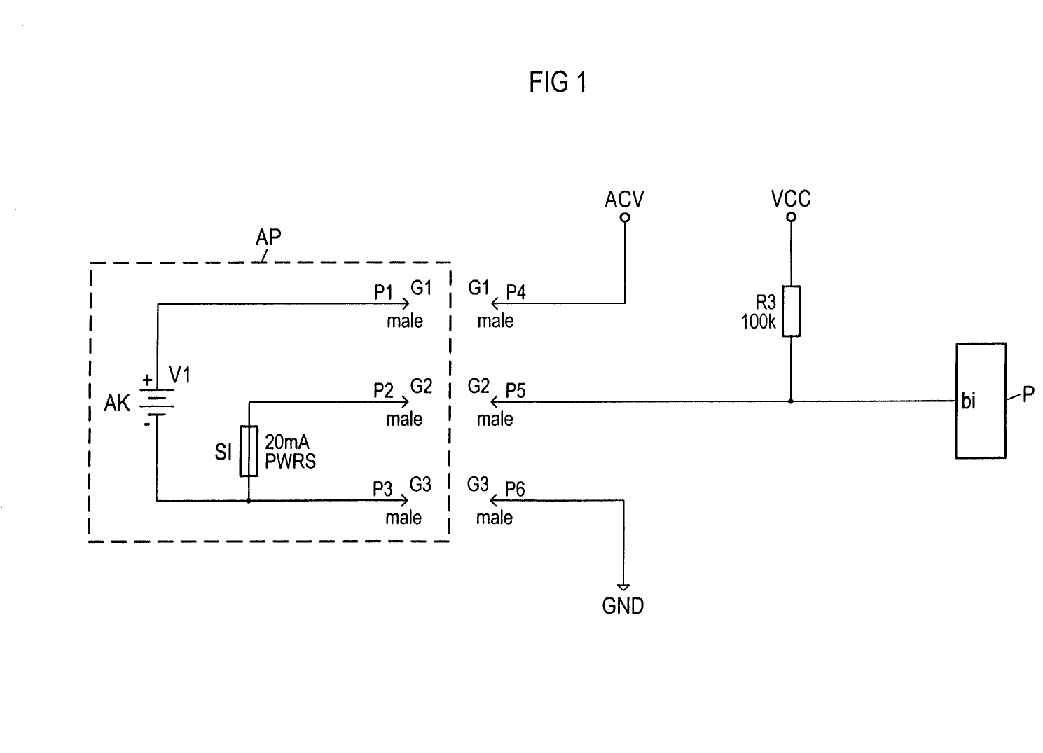

FIG. 1 a circuit arrangement of the invention having a processor comprising a bidirectional port; and

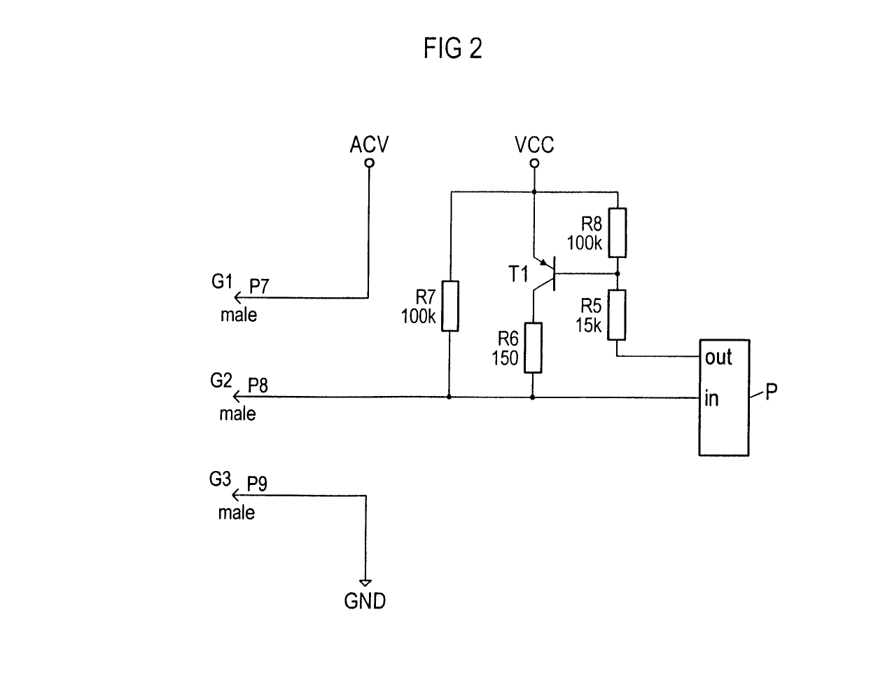

FIG. 2 a circuit arrangement of the application having a processor comprising a unidirectional port.

In the Figures, elements reference identically have the same functions.

In the circuit arrangement of FIG. 1, a processor P monitors a backup battery Ak for buffering the operating voltage of a circuit arrangement. The backup battery can be established by a primary element or by a secondary element. It is assumed below that the backup battery is established by an accumulator such as, for example, a nickel-cadmium accumulator or a nickel hydride accumulator. The terminal of the accumulator comprising the low potential (−) is connected to the one end of an element SI that is permanently irreversible with respect to electrically interrogatable quantities on the basis of a power surge. The element SI can be established by any type of element that permanently changes its electrically interrogatable properties due to a power surge. For example, the element can be a bistable electromagnetic relay whose excitation winding lies in series with a break contact. It is assumed below, that the element is established by a melt fuse. The accumulator and the element can be connectable to terminal posts by separate lead wires. In the exemplary embodiment of FIG. 1, the terminal of the accumulator exhibiting the low potential as well as the one end of the melt fuse are connected to a releasable terminal post P3, the other end of the melt fuse is connected to a releasable terminal post P2, and the terminal of the accumulator exhibiting the high potential (+) is connected to a releasable terminal post P1. Together with the melt fuse and the appertaining terminals, the accumulator forms a accupack AP. The terminal post P3 is connected to the reference potential GND of the circuit arrangement via a terminal post P6. The terminal post P1 is connected to a terminal accu-voltage ACV via a terminal post P4. In a circuit arrangement (not shown in detail) that is supplied with emergency power via a backup battery, the terminal post ACV forms the connecting point for the backup battery. Let the circuit arrangement (not shown in detail) be established by a radio-supported subscriber telecommunication terminal means that is connectable to a higher-ranking switching means via a radio interface according to the DECT standard in the framework of the radio-in-the-loop technology. The terminal post P2 is connected to a bidirectional port bi of a processor P via a terminal post P5. The port bi is connected to a terminal VDC via a high-impedance resistor R3, which may exhibit a resistance value of 100k, said terminal VDC exhibiting an operating voltage potential that lies above the reference potential GND.

The port is interrogated after a potential replacement of the backup battery. Given a low voltage level at the port, a conclusion is drawn that it is a new accupack and, given a high voltage level, a conclusion is drawn that it is a used accupack. A potential replacement of the backup battery can be established by a resetting of the circuit arrangement or in a cyclical interrogation. Of course, a potential replacement of the backup battery is also established when the circuit arrangement to be protected against a voltage outage determines a collapse of the backup voltage at the post ACV—while it is being supplied via the regular voltage supply—and derives a replacement of the backup battery by a new one therefrom. As reaction to a recognized replacement of the backup battery, let the processor store the point in time of the installation of the backup battery. The point in time of the installation of the new backup battery can be reported to a higher-ranking means (central), the switching means in the exemplary embodiment, and can be further-processed thereat.

After detection of the installation of a new backup battery, the fuse is destroyed by being charged with a power surge. According to the exemplary embodiment of FIG. 1, a fuse is provided that is so sensitive that it can be immediately destroyed by the current supplied at the output of the processor.

When the element SI exhibits the irreversible condition in an interrogation, i.e. the melt fuse is high-impedance, then it is concluded therefrom that the accumulator is not new.

According to a particular development of the subject matter of the application, the maximum charge amount that can be drawn from the backup battery is identified, and the irreversible element is placed into the irreversible condition when the maximum charge amount that can be drawn falls below a predetermined limit value.

The circuit arrangement according to FIG. 2 collaborates with the accupack AP from FIG. 1, whereby the terminal posts P1, P2 and P3 are connected to the posts P7, P8 and P9. The terminal post P8 is connected to a terminal IN of the processor that exhibits input functions. A terminal post VCC, which exhibits an operating potential lying above the reference potential GND, is connected to the terminal post P8 via a high-impedance resistor R7, which may be assumed to have a value of resistance of 100k. A transistor T1, which may be assumed to be established by a pnp-transistor of the type BC857c, and a resistor R6 that exhibits a value of resistance of 150 Ohms are connected parallel to the resistor R7, whereby the emitter of the transistor is connected to the terminal post VCC and the collector of the transistor is connected to the resistor R6. A resistor R8, which may be assumed to have a value of resistance of 100k, has its two ends connected to the terminal post VCC or, respectively, to the base of the transistor T1. A resistor R5, which may be assumed to have a value of resistance of 15k, has its two ends connected to the base of the transistor or, respectively, to a terminal of the processor OUT that exhibits an output function. A low potential at the terminal of the processor OUT effects an activation of the transistor T1, as a result whereof a power surge that destroys the fuse can flow. The transistor stage thus has a driver function. The interrogation of the condition of the irreversible element ensues via the terminal IN; the power surge for destroying the melt fuse is effected by a low potential at the terminal OUT.

1. Arrangement for maintaining the operating voltage of an electrical circuit, whereby a backup battery (Ak) and an element (SI) that is permanently irreversible with respect to electrically interrogatable quantities on the basis of a power surge are combined to form a replaceable unit.

2. Arrangement according to claim 1, characterized in that the unit is connectable to the electrical circuit via lead wires.

3. Arrangement according to claim 2, characterized in that the lead wires are combined in a plug connector secured against pole reversal that can interact with a counter piece connector of the electrical circuit.

4. Arrangement according to one of the preceding claims, characterized in that the element (SI) is a melt fuse.

5. Arrangement according to claim 4, characterized by a fuse that can be destroyed by a current intensity output at the terminal of a processor.

6. Arrangement according to claim 4, characterized in that the electrical circuit comprises a driver circuit formed with a transistor, and the fuse can be destroyed by the current intensity deliverable by the driver circuit.

7. Arrangement according to one of the preceding claims, characterized in that the backup battery is an accumulator.

8. Arrangement according to one of the preceding claims, characterized in that two elements (SI) are provided.

9. Method for recognizing the installation of a new backup battery in a circuit arrangement in which a backup battery arranged in common and an element (SI) that is permanently irreversible with respect to electrically interrogatable quantities on the basis of a power surge are replaceable, in accord wherewith
a check is carried out to see if the element (SI) is in its original condition;
when the element (SI) is in its original condition, the element (SI) is placed into the irreversible condition;
the point in time of setting the element (SI) into the irreversible condition is stored.

10. Method for recognizing the end of the service life of a backup battery in a circuit arrangement wherein a backup battery arranged in common and an element (SI) that is permanently irreversible with respect to electrically interrogatable quantities on the basis of a power surge are replaceable, whereby the following method steps are provided:
determining the maximum charge amount that can be drawn from the backup battery;
setting the element (SI) into the irreversible condition when the maximum charge amount that can be drawn falls below a predetermined limit value.
